(19) United States
(12) Patent Application Publication
(10) Pub. No.: US 2014/0172647 A1
(43) Pub. Date: Jun. 19, 2014

(54) Tax Aware Price Displays

(71) Applicants: Richard Neil Cancro, Portland, OR (US); Joel Bennett Acker, JR., Brush Prairie, WA (US); Douglas James Pedley, Portland, OR (US)

(72) Inventors: Richard Neil Cancro, Portland, OR (US); Joel Bennett Acker, JR., Brush Prairie, WA (US); Douglas James Pedley, Portland, OR (US)

(73) Assignee: Wal-Mart Stores, Inc., Bentonville, AR (US)

(21) Appl. No.: 13/718,918

(22) Filed: Dec. 18, 2012

(51) Int. Cl. G06Q 30/06

(52) U.S. Cl. CPC G06Q 30/0641
USPC 705/27.1

(57) ABSTRACT

A method for sending a cost notification to a display monitor corresponding to a display apparatus, the display apparatus furnished within a facility includes obtaining display apparatus information corresponding the display apparatus. The display apparatus information includes display apparatus preferences being indicative of an item explicitly preferred by the retailer for being stocked at the display apparatus. The display apparatus information further includes location specific information being indicative of a geographical location of the facility at which the display apparatus is furnished within. A cost notification related to the item is generated based on the display apparatus information and the generated cost notification is transmitted to the display monitor.

### BACKGROUND INFORMATION

1. Field of the Disclosure

The present invention relates generally to systems and methods for displaying costs of items stocked on a display apparatus within a facility. In particular, examples of the present invention are related to techniques for retrieving a sales tax rate applicable to an item stocked at a display apparatus and displaying a gross cost that reflects a true cost for purchasing the item including an applied sales tax to the item on a display monitor corresponding to the display apparatus.

2. Background

Shelves and garment racks, hereinafter display apparatuses, are furnished within shopping facilities to display and present items offered for sale by a retailer. The retailer may explicitly prefer selected items for presentation on each display apparatus to organize the items and make it easy for a customer to locate desirable items. Dedicated display monitors including digital LCD or digital LED screens may be used to present descriptions of the selected items and advertise a retail price, e.g., a net cost, related to items stocked at the display apparatuses.

One drawback of only advertising the retail price is that the true cost the customer will pay at checkout is not made known to the customer if the item is taxable by a governing body, e.g., a state's sales tax rate. In this scenario, a customer on a budget may quickly accrue increased costs not accounted for based on sales tax rates applicable to items he or she purchases at checkout. Further, it may be difficult for a customer to perform math while shopping in order to calculate an applied sales tax to an item the customer desires to purchase.

Further, certain classifications of items are exempt from being taxed while other classifications are taxable. Similarly, one geographical location, such as a specific county of a state, may apply a higher sales tax rate to an item than another geographical location, such as another county in the same state. Accordingly, the gross cost of the item can vary depending on a governing body encompassing the geographical location the item is purchased within, making it difficult for a retailer operating in multiple locations to advertise gross costs that may fluctuate.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 schematically illustrates a display apparatus server in communication with a display apparatus, a display monitor and a retailer computing device, in accordance with an exemplary embodiment of the present disclosure;

FIGS. 2A-2F schematically illustrate non-limiting examples of items having different classifications stocked at the display apparatus of FIG. 1, in accordance with an exemplary embodiment of the present disclosure;

FIGS. 3A-3F schematically illustrate non-limiting examples of generated cost notifications displayed on a screen of the display monitor of FIG. 1;

FIG. 4 is a block diagram illustrating components of the display apparatus server of FIG. 1, in accordance with an exemplary embodiment of the present disclosure;

FIG. 5 is a block diagram illustrating components of the display apparatus of FIG. 1, in accordance with an exemplary embodiment of the present disclosure; and

FIG. 6 is a flowchart illustrating an example method for generating a cost notification related to an item stocked at a display apparatus and transmitting the generated cost notification to a display monitor corresponding to the display apparatus, in accordance with an exemplary embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. Techniques for generating a notification based on user information when a presence of the mobile computing device is detected in a facility are described herein. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

It may desirable to advertise a gross cost to purchase an item offered for sale by the retailer and stocked at a display apparatus furnished within a facility of a retailer. As used herein, the term “gross cost” can refer to an actual or true cost a customer pays at a checkout of the facility to purchase the item including any applicable sales tax rate. Specifically, the gross cost includes a sum of a net cost of the item and an applied sales tax to the item.

As used herein, the term “net cost” can refer to an advertised retail price offered by the retailer to purchase an item excluding any applicable sales tax rate. As used herein, the term “sales tax rate” can refer to any sales tax rate imposed by a governing body on an item. As used herein, the term “classification” can refer to any type of indicator of an item that the governing body defines as taxable or exempt from taxation. As will be discussed below, a classification that is exempt as being taxable by a governing body, will include a sales tax rate equal to zero. The governing body imposing the sales tax rate encompasses a geographical location of a facility of a retailer offering the item for sale. Accordingly, the geographical location can include a country, state, province, country or municipality. As used herein, the term “facility” can refer to shopping venues, complexes and department stores, wherein a “facility attendant” can refer to one or more individuals, managers, stock persons, inventory personal, cashiers, or greeters employed by the retailer at a specific facility and on duty. As used herein, the term “item” can refer to any type of indicator of a product sold by a retailer and the term “product” can refer to groceries, foods, prepared foods, office supplies, clothing wares, or any other fungible goods sold by a retailer.

Embodiments are directed toward generating a cost notification related to an item stocked at a display apparatus furnished within a facility of the retailer. The cost notification is based on display apparatus information corresponding to the display apparatus. The display apparatus information can include display apparatus preferences being indicative of an item explicitly preferred by the retailer for being stocked at the display apparatus and location specific information being indicative of a geographical location of the facility the display apparatus is furnished within. The display apparatus can be a shelf apparatus and a garment rack apparatus. The display apparatus can be equipped with a display monitor to present and display notifications, promotions, or other information related to the item stocked at the display apparatus to customers shopping within the facility. Accordingly, the cost notification can be transmitted to the display monitor and displayed for a perspective customer to view. The generated cost notification can include a “gross cost” to purchase an item. Similarly, the generated cost notification can further include a description of the item and a “net cost” or “retail price” to purchase the item and any sales tax rates imposed by a governing body and an applied sales tax to the item. The generated cost notification simply provides a cost breakdown of what a customer can expect to pay upon purchasing an item at a checkout of the facility.

As used herein, the term “display monitor” can refer to any screen, touch screen, interface or other display device, including a digital LCD or LED screen. Furthermore, the term “promotion” can refer to sales, coupons, and advertisements related to the item offered by the retailer.

It will be appreciated that providing the customer with the gross cost to purchase the item offered for sale by the retailer permits the customer to be aware of the total or true cost that the customer will pay at checkout, e.g., out the door price. Customers will accordingly be able to more closely monitor their budget when shopping.

It will be further appreciated that display apparatuses configured to broadcast display apparatus identifiers to one or more servers allows for the retrieval of item information using an item identifier corresponding to the item currently stocked at the display apparatus. The item identifier can be a Universal Product Code (UPC). Using the item identifier, the retrieved item information can include a net cost offered by the retailer to purchase the item and a classification corresponding to the item. In one embodiment, a non-zero integer corresponding to a sales tax rate applicable to the item can be obtained when the geographical location of the facility defines the classification of the item as taxable. Similarly, it can be determined that a sales tax rate applicable to the item is equal to zero when the geographical location of the facility defines the classification of the item as being exempt from being taxable. Accordingly, a display apparatus server communicating with the display apparatus can be aware of what item is stocked at the display apparatus, the classification of the item, the geographical location of the facility at which the display apparatus is stocked, and if the item is taxable or exempt from being taxable by using the geographical location of the facility and the classification of the item.

Facilities are equipped with computing devices to input and view information. As used herein, the term “computing device” can refer to mobile computing devices, such as mobile telephones, laptop computers, and tablet computers, or stationary computing devices. For example, a computing device stationed in a department of the facility may input display apparatus information, including the display apparatus preferences and the location specific information, into a display apparatus database of the notification server. The display apparatus information can be retrieved using a display apparatus identifier broadcasted from a display apparatus. Additionally, the computing device may input item information corresponding to the item in an item database. The item information, including the net cost to purchase the item and the classification of the item, can be retrieved from the item database using an item identifier corresponding to the item. Furthermore, the computing device may input whether or not the item is taxable or exempt from being taxable as defined by a governing body encompassing the geographical location of the facility at which the display apparatus stocking the item is furnished within. Accordingly, the sales tax rate can be retrieved from the sales tax database using the geographical location of the facility and the classification of the item.

In accordance with various embodiments of the present disclosure, techniques are described for transmitting a cost notification to a display monitor corresponding to a display apparatus. The cost notification can be indicative of a gross cost to purchase an item, a net cost to purchase an item, a non-zero integer corresponding to a sales tax rate applicable to the item, and an applied tax to the item currently stocked at the display apparatus. Thus, the cost notification may provide a cost breakdown of what a customer can expect to incur when purchasing an item. As aforementioned, a non-zero integer corresponding to a sales tax rate applicable to the item can be obtained when a geographical location of a facility at which the display apparatus is furnished within defines the classification of the item as taxable. For instance, a display apparatus furnished within a facility of Chicago, Ill., may apply a sales tax rate of 10% to a music album stocked at the display apparatus. Whereas, another display apparatus furnished within Springfield, Ill., and stocking the same music album, may apply a sales tax rate of 6% to the music album. Hence, while the music album includes a classification as taxable in both geographical locations, purchasing the music album in Chicago includes a higher sales tax rate, and thus, an increased applied tax rate to the music album and an increased gross cost to purchase the music album. It will be further appreciated that items having a classification may be taxable within one geographical location but may be exempt from being taxable within another geographical location. Accordingly, providing a display apparatus configured to broadcast a display apparatus identifier to a display apparatus server and retrieving display apparatus information using the display apparatus identifier at the display apparatus server, enables the ability of the display apparatus server to quickly and efficiently determine whether or not a classification of an item explicitly preferred by the retailer to be stocked at the display apparatus is taxable or exempt from being taxable. If the classification of the item is taxable, the non-zero integer corresponding to the sales tax rate applicable to the item can be obtained using the geographical location and the classification. Similarly, if the classification of the item is exempt from being taxable, the gross cost is simply equal to the net cost to purchase the item because no applied sales tax will result.

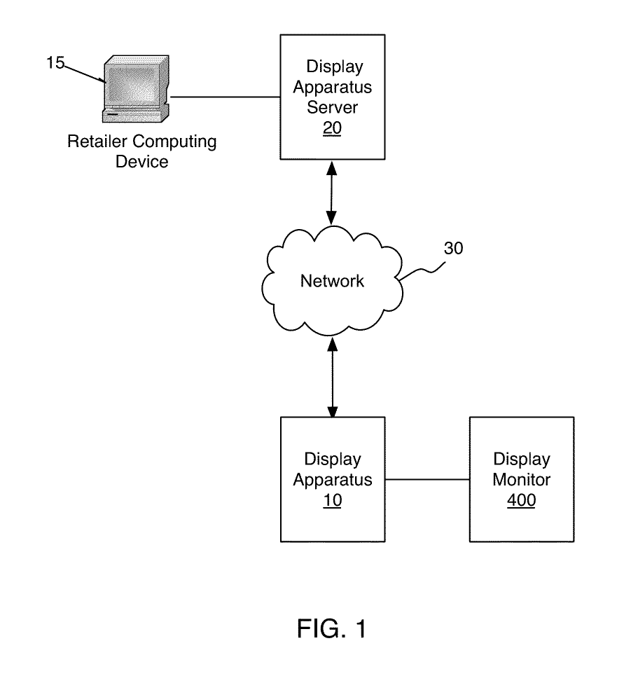

FIG. 1 illustrates a display apparatus server 20 in communication with a display apparatus 10 and a retailer computing device 15. The retailer computing device 15 can include a stationary computing device corresponding to a specific section of the facility, e.g., a sporting good department service desk, or a mobile computing device corresponding to a facility attendant. While one display apparatus server 20 is illustrated, the term “display apparatus server” refers to one or more servers that operate in an individual or distributed manner. For instance, each display apparatus may include a respective “display apparatus server” or one “display apparatus server” may operate a plurality of display apparatuses. While one retailer computing device 15 is illustrated, the term “retailer computing device” refers to one or more computing devices that operate to transmit one or more inputs to the display apparatus server 20 for inputting into respective databases: display apparatus information, item information, and sales tax rates corresponding to a plurality of item classifications and a plurality of geographical locations.

While one display apparatus 10 is illustrated, the term “display apparatus” may include one or more display apparatuses furnished within the facility or furnished within a plurality of facilities of the retailer. In the illustrated example, the display apparatus server 20 may receive a display apparatus identifier broadcasted from the display apparatus 10 via the network 30. Display apparatus information may then be retrieved from a display apparatus database using the display apparatus identifier. Embodiments include the display apparatus information including location specific information and display apparatus preferences provided by the retailer and stored in the display apparatus database. For instance, a facility manager may provide the display apparatus preferences using the retailer computing device 15, wherein the display apparatus preferences may be indicative of an item explicitly preferred by the retailer for being stocked at the display apparatus 10. The location specific information can include information being indicative of a geographical location of the facility the display apparatus is furnished within. It will be appreciated that a governing body encompassing the geographical location may define certain item classifications as taxable and certain item classifications as exempt from being taxable. Embodiments include the geographical location of the display apparatus selected from the group consisting of: a country, a state, a province, a county, a borough, and a municipality. Further, as used herein, the term “network” can refer to any communication network including, but not limited to, a wireless network, a cellular network, an intranet, the Internet, or combinations thereof.

A processing device of the display apparatus server 20 may use an item identifier, e.g., a UPC, corresponding to the item explicitly preferred by the retailer for being stocked at the display apparatus 10 to retrieve item information from an item database. For instance, a facility manager may provide the item information using the retailer computing device 15, wherein the item information may be indicative of a net cost to purchase the item offered by the retailer and a classification of the item. Thereafter, the processing device of the display apparatus server 20 may retrieve a sales tax rate applicable to the item from a sales tax database using the geographical location of the facility and the classification. The classification may be taxable or exempt from being taxable. For instance, a facility manager may provide a non-zero integer corresponding to the sales tax rate applicable to the item when a governing body encompassing the geographical location at which the display apparatus is located within defines the classification of the item as taxable by the sales tax rate. Similarly, the processing device of the display apparatus server 20 may determine that the sales tax rate applicable to the item is equal to zero when the geographical location of the facility defines the classification of the item as exempt from being taxable. The classification of the item is selected from the group consisting of: groceries, prepared food, prescription medication, non-prescription medication, clothing, agricultural, alcohol/tobacco, and generally taxed items.

The display apparatus 10 may further be equipped with a dedicated display monitor 400. The display apparatus server 20 can operate to transmit one or more cost notifications, generated by the processing device, related to the item currently stocked at the display apparatus. The generated cost notifications can include the gross cost to purchase the item, the net cost to purchase the item, the non-zero integer corresponding to the sales tax rate applicable to the item, and an applied sales tax to the item. The generated cost notifications can be transmitted from the display apparatus server 20 to the display apparatus 10 via the network 30 and displayed upon the display monitor 400 and viewed by customers within the facility. Alternatively, the display monitor 400 can be configured to directly receive the generated cost notification transmitted from the display apparatus server 20 via the network 30.

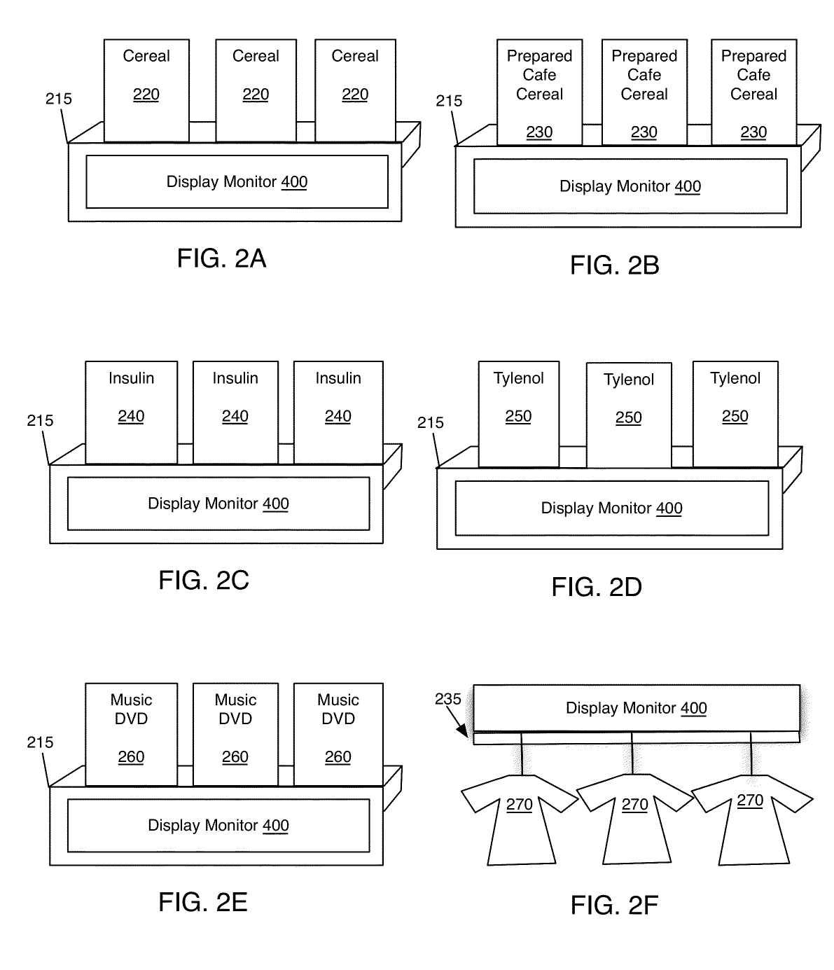

FIGS. 2A-2F schematically illustrate non-limiting examples of items having different classifications stocked at the display apparatus of FIG. 1, in accordance with an exemplary embodiment of the present disclosure. FIGS. 2A-2E schematically illustrate the display apparatus 10 corresponding to a shelf apparatus 215 equipped with the display monitor 400. FIG. 2F schematically illustrates the display apparatus 10 corresponding to a garment rack apparatus 235 equipped with the display monitor 400.

In the illustrated example of FIG. 2A, the shelf apparatus is currently stocking boxes of “Cereal” 220. The classification of the cereal 220 includes groceries. Accordingly, if a geographical location of the facility that the shelf apparatus 215 is furnished within defines groceries as taxable, a non-zero integer corresponding to the sales tax rate applicable to the item can be retrieved from a sales tax database. For instance, if the geographical location corresponds to the state of Hawaii, groceries are taxable and the sales tax rate is 4%. However, if the geographical location corresponds to the state of Michigan, groceries are exempt from being taxable and the sales tax rate applicable to the item is zero. It will be further appreciated some geographical locations may further divide groceries into sub-categories where one sub-category may be exempt from being taxable while another sub-category can be defined as taxable and including a respective sales tax rate.

FIG. 2B illustrates the shelf apparatus 215 currently stocking “Prepared Café Cereal” 230. In the illustrated example, the cereal is prepared by the retailer and sold at the café. In such an instance, the classification of the “Prepared Café Cereal” 230 is prepared food. Prepared food may be distinguishable from groceries in that the prepared may be defined as taxable by a given geographical location, whereas groceries may be defined as being exempt from being taxable. For instance, the state of Nebraska defines prepared food as taxable including a sales tax rate of 5.5%. However, if the geographical location of the facility at which the display apparatus stocking the prepared food is within includes Omaha, Nebr., the sales tax rate would be 9.5%

FIG. 2C illustrates the shelf apparatus 215 currently stocking “Insulin” 240, a prescribed medication for Diabetics offered in a pharmacy of the retailer. In the illustrated example, the classification of the “Insulin” is a prescription medication. In a state such as Kentucky, prescription medications are exempt from being taxable. FIG. 2D illustrates the shelf apparatus 215 currently stocking “Tylenol” 250. In the illustrated example, the classification of the “Tylenol” is a non-prescription medication. Unlike a prescription medication illustrated in FIG. 2C, the non-prescription medication may be defined as taxable. For instance, Kentucky defines prescription medications as exempt from being taxable but defines prescription medications as being taxable. Accordingly, a sales tax rate of 6% would be applicable to the “Tylenol” in the state of Kentucky.

FIG. 2E illustrates the shelf apparatus 215 currently stocking a “Music DVD” 260. In the illustrated example, the classification of the “Music DVD” is a generally taxable item. Hence, the term “generally taxable item” can refer to general merchandise items that generally are not exempt from being taxable by most governing bodies encompassing respective geographical locations. For instance, if the shelf apparatus 215 is furnished within a facility located within South Dakota, a 4% sales tax rate would be applied to the “Music DVD” 260. However, if the shelf apparatus 215 is furnished within a facility located within Alaska, no applied sales tax would to the “Music DVD” 260 is incurred because Alaska does not impose a state-wide sales tax unless the classification of the item is prepared food.

FIG. 2F illustrates the garment rack apparatus 235 currently stocking a shirt 270. In the illustrated example, the classification of the shirt 270 is clothing. Within some geographical locations, clothing is exempt from being taxable. For instance, New Jersey exempts clothing from being taxable. However, some geographical locations may impose an increased sales tax rate to clothing if the net cost exceeds a certain value. For instance, the state of New York may impose a sales tax rate of 4% if the net cost of the clothing exceeds $110.

The examples of FIGS. 2A-2F are provided for example only and not intended to be limiting. It will be appreciated that the classifications of the items are not limited to only illustrated non-limiting examples FIGS. 2A-2F, but can further include classifications such as alcohol and tobacco that may be defined as taxable and having special sales tax rates imposed by a governing body encompassing the geographical location of the facility at which a given display apparatus is furnished within.

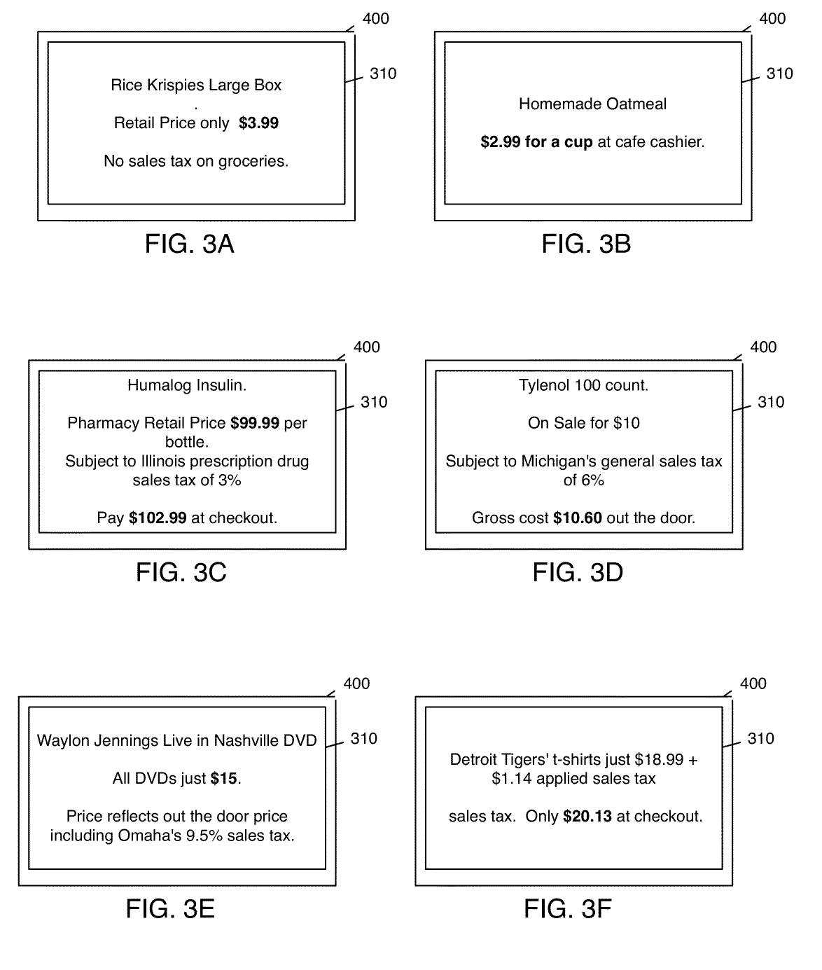

FIGS. 3A-3F schematically illustrate non-limiting examples of generated cost notifications displayed on a screen of the display monitor of FIG. 1. The display monitor 400 in each of FIGS. 3A-3F may include a digital LCD or digital LED screen 310. The screen 310 may further display a graphical user interface (GUI) permitting a user to interact with the display monitor. The graphical user interface may display at least one operational input that allows the user to provide a command, e.g., provide an item description, to the display monitor 400, the command causing the mobile computing device 10 to perform one or more operations.

It will be understood that the displayed notifications are not limited to any size or shape. Embodiments are envisioned where the generated cost notification can be displayed as a dynamic banner that moves across the display monitor 400. Additionally, the generated cost notification may flash or change colors. The generated cost notification may further provide a brief item description such as what the item pertains to.

In one embodiment, the generated cost notification transmitted to the display monitor 400 can include a gross cost of the item currently stocked at the display apparatus. The gross cost reflects a true price a customer will pay at checkout of the retailer. In embodiments where an item is exempt from being taxable, the gross cost is equal to the net cost because no there is not applied sales tax to the item. FIG. 3A illustrates a non-limiting example of only the gross cost, e.g., equal to the net cost, to purchase “Rice Krispies” cereal displayed upon the display monitor 400. In this non-limiting example, the classification of cereal corresponds to groceries that are exempt from being taxable in the geographical location at which the display apparatus stocking the cereal is furnished within, and therefore the gross cost is equal to the net cost. Similarly, FIG. 3B illustrates a non-limiting example of only the gross cost, e.g., equal to the net cost, to purchase “Homemade Oatmeal” displayed upon the display apparatus 400. In this non-limiting example, prepared food such as “Homemade Oatmeal” offered for sale in a facility café corresponds to a classification of prepared food that is exempt from being taxable in the geographical location at which the display apparatus stocking the prepared food is furnished within, and therefore the gross cost is equal to the net cost.

In another embodiment, the generated cost notification transmitted to the display apparatus equipped with the display monitor 400 can include a net cost of the item, a non-zero integer corresponding to the sales tax rate applicable to the item and a gross cost of the item. FIG. 3C illustrates a non-limiting example of the net cost, a non-zero integer corresponding to the sales tax rate and a gross cost of the item “Insulin” displayed upon the display monitor 400. In this non-limiting example, “Insulin” corresponds to a classification of prescription medication that includes a non-zero integer corresponding to a sales tax rate, e.g., 1%, applicable to prescription medication in Illinois. FIG. 3D illustrates a non-limiting example of the net cost, a non-zero integer corresponding to the sales tax rate and a gross cost of the item “Tylenol” displayed upon the display monitor 400. In this non-limiting example, the classification of “Tylenol” corresponds to a non-prescription medication that includes a non-zero integer corresponding to the sales tax rate, e.g., 6% applicable to non-prescription medication in Michigan.

In another embodiment, the generated cost notification transmitted to the display apparatus equipped with the display monitor 400 can include a gross cost and a non-zero integer corresponding to a sales tax rate applicable to the item. FIG. 3E illustrates a non-limiting example of the gross cost, e.g., out the door price, and non-zero integer corresponding to a sales tax rate, e.g., Omaha's 9% sales tax rate, applicable to a “DVD” displayed upon the display monitor 400. In this non-limiting example, a DVD corresponds to a classification of generally taxable item that is defined by Omaha as being taxable.

In another embodiment, the generated cost notification transmitted to the display apparatus equipped with the display monitor 400 can include a net cost of the item, an applied tax rate to the item and a gross cost of the item. The applied tax rate is calculated by multiplying the net cost by a non-zero integer corresponding to a sales tax rate applicable to the item. FIG. 3F illustrates a non-limiting example of the net cost of the item, an applied tax rate to the item and a gross cost of the item that includes “Detroit Tigers t-shirts” displayed upon the display monitor 400. In this non-limiting example, “Detroit Tigers t-shirts” corresponds to a classification of clothing that includes non-zero integer corresponding to a sales tax rate, e.g., 6% sales tax in Michigan. Accordingly, the applied tax rate is equal to $1.14, e.g., $18.99 multiplied by 6%.

The examples of FIGS. 3A-3F are provided for example only and not intended to be limiting. It will be appreciated that the generated cost notification is not limited to one type, but each generated cost notification may include any combination of the gross cost of the item, the net cost of the item, the non-zero integer corresponding to the sales tax rate applicable to the item, and an the applied sales tax of the item transmitted to the display monitor 400 and based on geographical location of the facility and the classification of the item.

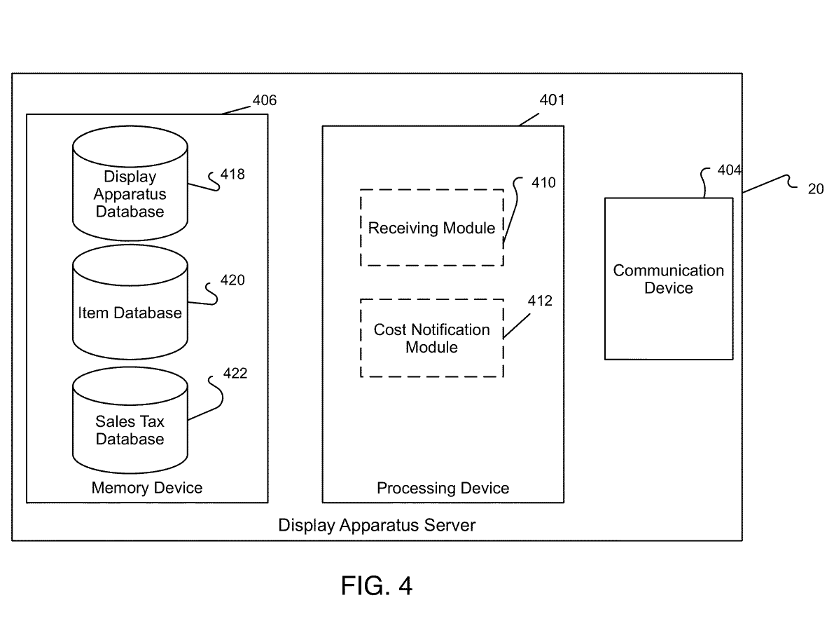

Referring now to FIG. 4, a block diagram illustrating example components of the display apparatus server 20 of FIG. 1 is depicted. In an exemplary embodiment, the display apparatus server 20 includes a processing device 401, a communication device 404, and a memory device 406.

The processing device 401 can include memory, e.g., read only memory (ROM) and random access memory (RAM), storing processor-executable instructions and one or more processors that execute the processor-executable instructions. In embodiments where the processing device 401 includes two or more processors, the processors can operate in a parallel or distributed manner. In the illustrative embodiment, the processing device 401 executes a receiving module 410 and a cost notification module 412, which are described in greater detail below.

The receiving module 410 can receive a display apparatus identifier broadcasted from the display apparatus. The cost notification module 412 can thereby obtain display apparatus information using the display apparatus identifier received at the receiving module 410. Specifically, the cost notification module 412 retrieves the display apparatus information from a display apparatus database 418 using the display apparatus identifier. The display apparatus information can include display apparatus preferences being indicative of an item explicitly preferred by the retailer for being stocked at the display apparatus, and location specific information being indicative of a geographical location of the facility the display apparatus is furnished within. It will be understood that a governing body imposing sales tax rates to items encompasses the geographical location, wherein the governing body can define the item as being taxable or as being exempt from being taxable. It will be further appreciated that items being taxable include a non-zero integer corresponding to the sales tax rate applicable to the item and items being exempt from being taxable include a sales tax rate equal to zero, e.g., no sales tax rate. Accordingly, the geographical location of the display apparatus is selected from the group consisting of: a country, a state, a county, a borough, and a municipality.

The cost notification module 412 is further configured to retrieve item information from an item database 420 using an item identifier corresponding to the item, and a classification of the item. The net cost of the item includes a cost offered by the retailer to purchase the item excluding any applicable sales tax rate. The classification of the item is selected from the group consisting of: groceries, prepared food, prescription medication, non-prescription medication, clothing, agricultural, alcohol/tobacco, and generally taxed items. Non-limiting examples of classifications of items are discussed above in the non-limiting examples of FIGS. 2A-2F.

In an exemplary embodiment, the cost notification module 412 can retrieve a sales tax rate applicable to the item from a sales tax database using the geographical location of the facility and the classification of the item. A gross cost of the item can be calculated based on the net cost of the item and the sales tax rate. The gross cost indicates a cost to purchase the item at a checkout of the facility. Simply put, the gross cost is a true cost, e.g., price out the door, that reflects a sales tax rate applied to the purchased item. In one embodiment, when the geographical location of the facility defines the classification of the item as being exempt from being taxable, the cost notification module 412 determines that the sales tax rate applicable to the item is equal to zero and the gross cost is equal to the net cost. Thus, because the item is exempt from being taxable, a sales tax rate is not applied to the item, and therefore, the net cost of the item reflects the gross cost that a customer will pay to purchase the item at checkout. In another embodiment, when the geographical location of the facility defines the classification of the item as being taxable, the cost notification module 412 first retrieves a non-zero integer from the sales tax database using the geographical location of the facility and classification of the item. The non-zero integer corresponds to the sales tax rate applicable to the item. In a non-limiting example, an item that is taxable in Michigan would include a non-zero integer equal to 6% corresponding to Michigan's sales tax rate applicable to the taxable item. Next, the cost notification module 412 multiplies the non-zero integer by the net cost of the item to determine an applied sales tax to the item. By adding the applied sales tax and the net cost of the item, the cost notification module 412 may determine the gross cost of the item. Thus, the gross cost of the item includes the net cost and any applied sales tax a customer will pay upon purchasing the item at checkout.

The cost notification module 412 generates a cost notification related to the item based upon the retrieved geographical location of the facility and the classification of the item. The generated cost notification can include the gross cost of the item, the net cost of the item, the non-zero integer corresponding to the sales tax rate applicable to the item and the applied sales tax to the item discussed above in the non-limiting examples provided in FIGS. 3A-3F. In one example, when the geographical location of the facility defines the classification of the item as being exempt from being taxable, the generated cost notification may only indicative of the gross cost. In another example, when the geographical location of the facility defines the classification of the item as being taxable, the generated cost notification may be indicative of the gross cost of the item and any combination of the net cost of the item, the non-zero integer, and the applied sales tax to the item to provide a breakdown of all costs that will be incurred by a customer purchasing the item upon checking out. The generated cost notification may further include a description of the item or any other advertisement or promotion related to the item. Thereafter, the generated cost notification is transmitted to the display monitor 400 corresponding to the display apparatus 10 of FIG. 1.

The communication device 404 is a device that allows the display apparatus server 20 to communicate with another device, e.g., the display apparatus 10, via the network 30. The communication device 404 can include one or more wireless transceivers for performing wireless communication and/or one or more communication ports for performing wired communication.

The memory device 406 is a device that stores data generated or received by the display apparatus server 20. The memory device 406 can include, but is not limited to, a hard disc drive, an optical disc drive, and/or flash memory drive. Further, the memory device 406 may be distributed and located at multiple locations. The memory device 406 is accessible to the processing device 400.

A display apparatus database 418, or similar structure, can be stored in the memory device 406. In an exemplary embodiment, a retailer maintains the display apparatus database 418 to input and store display apparatus information for one or more display apparatuses furnished by the retailer. For instance, a facility manager may input the display apparatus information for one or more display apparatuses within one or more facilities using the retailer computing device 15 of FIG. 1. As aforementioned, the display apparatus information can include the display apparatus preferences and the location specific information of the facility at which the display apparatus is furnished within.

Additionally, the item database 420, or similar structure, can be stored in the memory device 406. In an exemplary embodiment, the retailer maintains the item database 420 to store item information corresponding to one or more items being offered for sale by the retailer. As aforementioned, the item information can include the net cost of the item and the classification of the item. The item information corresponding the item may be retrieved from the item database 420 by the notification module 412, wherein the notification module 412 uses the display apparatus information from the display apparatus database 418 to obtain the item identifier, e.g., UPC, corresponding to the item explicitly preferred by the retailer for being stocked at the display apparatus.

Further, the sales tax database 422, or similar structure, can be stored in the memory device 406. In an exemplary embodiment, a retailer maintains the sales tax database 422 to store a plurality of sales tax rates corresponding to a plurality of classifications defined by a plurality of geographical locations as being one of taxable and exempt from being taxable. For instance, for each of a plurality of item classifications, a facility attendant can sort whether each classification is taxable or whether each classification is exempt from being taxable as defined by a governing body encompassing a geographical location at which the facility is located within. Accordingly, the facility attendant can input a sales tax rate applicable to the item that is equal to zero when the classification is exempt from being taxable. Likewise, the facility attendant can input a non-zero integer corresponding to the sales tax rate applicable to the item when the classification is taxable. In a non-limiting example, the sales tax database 422 may be arranged such that one or more classifications and one or more geographical locations are laid out in a two-dimensional table, wherein a determination can be made on whether each of the one or more classifications are taxable or exempt from being taxable. Accordingly, the sales tax rate, e.g., zero or a non-zero integer, applicable to each of the classifications can be retrieved for each of the geographical locations. Using the sales tax rate applicable to the item, the cost notification module 412 can calculate the gross cost of the item. In one embodiment, when the sales tax rate is zero, e.g., the item is exempt from being taxable, the gross cost is simply equal to the net cost of the item. In another embodiment, when the sales tax rate is a non-zero integer, e.g., the item is taxable, the gross cost includes the sum of the net cost and an applied tax to the item, the applied tax based on multiplying the non-zero integer by the net cost. Embodiments are directed toward the cost generation module 412 generating a cost notification related to the item and can be indicative of the gross cost of the item, the net cost of the item, the non-zero integer corresponding to the sales tax rate applicable to the item and the applied sales tax to the item discussed above in the non-limiting examples provided in FIGS. 3A-3F. The generated cost notification is thereby transmitted from the cost notification module 412 using the communication device 404 to the display monitor 400 corresponding to the display apparatus 10 of FIG. 1. Providing a customer with a cost notification that includes the gross cost is beneficial for a customer to quickly determine the true cost of what the customer will be paying at checkout if the customer purchases the item.

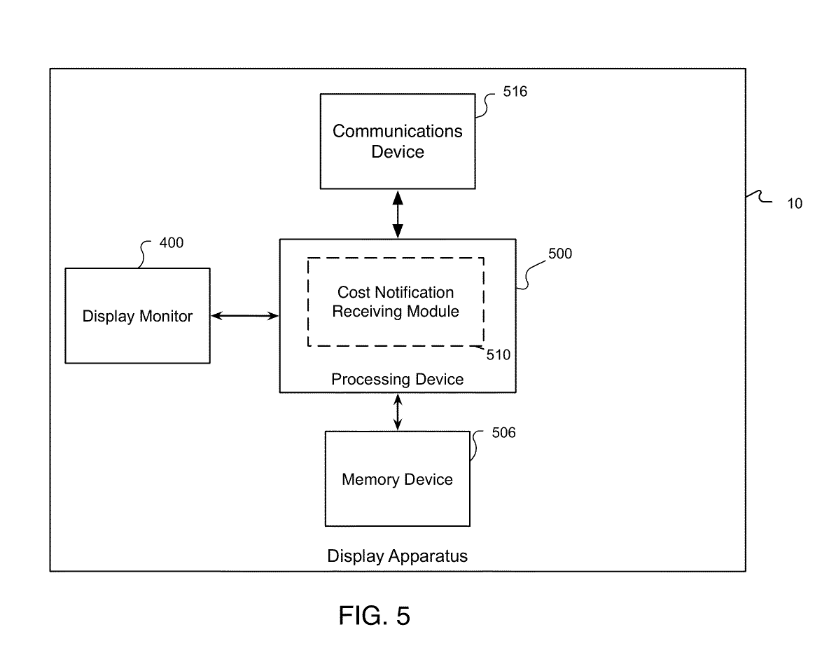

Referring now to FIG. 5, a block diagram illustrating example components of the display apparatus 10 of FIG. 1 is depicted. In the example embodiment, the display apparatus 10 includes a processing device 500, a memory device 506, a communications device 516 and a display monitor 400.

The processing device can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 500 can execute the operating system of the display apparatus. In the illustrative embodiment, the processing device 500 also includes a cost notification receiving module 510 for receiving a generated cost notification transmitted from the display apparatus server 20 of FIG. 1 and an item identifier module 512 for displaying the generated cost notification upon the display monitor.

The communication device 516 is a device that allows the display apparatus 10 to communicate with another device, e.g., the display apparatus server 20, via the network 30. The communication device 516 can include one or more wireless transceivers for performing wireless communication and/or one or more communication ports for performing wired communication. The memory device 508 is a device that stores data generated or received by the display apparatus 10. The memory device 106 can include, but is not limited to a hard disc drive, an optical disc drive, and/or a flash memory drive. The memory device 508 can include storage for a received on or more generated cost notifications.

The display monitor 400 is a dedicated device configured to display the received generated cost notification through the communications device 516. The display monitor 400 may be integrated within the display apparatus 10 and may include a digital LCD screen or a digital LED screen. Alternatively, the display monitor, while dedicated to the display apparatus, may be entirely separate from the display apparatus and be configured to directly receive the generated cost notification from the display apparatus server 20 of FIG. 1. Alternatively, the display monitor 400 may be dedicated to one or more display apparatuses.

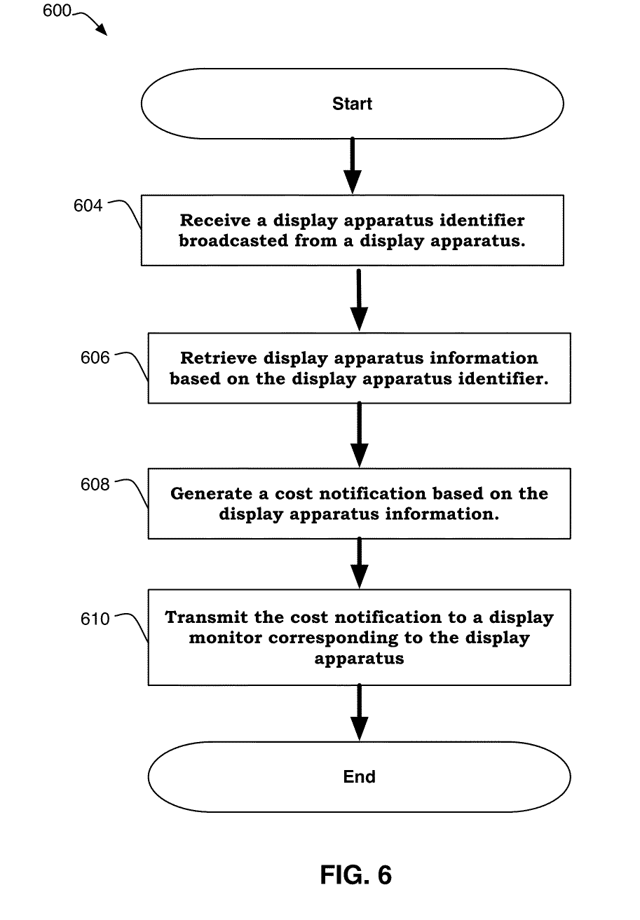

FIG. 6 illustrates an example method of a flowchart 600 that can be executed by the display apparatus server 20 sending a generated cost notification from the display apparatus server 20 to the display monitor 400 corresponding to the display apparatus 10. At operation 604, the receiving module 410 receives a display apparatus identifier broadcasted from the display apparatus 10. At operation 606, the cost notification module 412 retrieves display apparatus information from the display apparatus database 418 using the display apparatus identifier. The display apparatus information may include display apparatus preferences and location specific information. The display apparatus preferences are of an item explicitly preferred by the retailer for being stocked at the display apparatus 10. The location specific information is indicative of a geographical location of the facility at which the display apparatus 10 is furnished within. Using an item identifier corresponding to the item, e.g., a UPC, the cost notification module 412 may retrieve item information from the item database 410, wherein the item information includes a net cost of the item offered by the retailer to purchase the item excluding any sales tax rate applicable to the item and a classification of the item. As previously mentioned, the classification of the item can include groceries, prepared food, prescription medication, non-prescription medication, clothing, agricultural, alcohol/tobacco, and generally taxed items.

At operation 608, the cost notification module 412 generates a cost notification based on the display apparatus information. In an exemplary embodiment, the cost notification module 412 generates the cost notification related to the item using the geographical location of the facility and the classification of the item. The cost notification module 412 can retrieve a sales tax rate applicable to the item from a sales tax database using the geographical location of the facility and the classification of the item. In one embodiment, the sales tax rate applicable to the item can be equal to zero when the geographical location of the facility defines the classification of the item as being exempt from being taxable. In this scenario, a gross cost of the item is equal to the net cost because the customer will not incur a sales tax rate. In another embodiment, the sales tax rate applicable to the item can be a non-zero integer when the geographical location of the facility defines the classification of the item as being taxable. In this scenario, the gross cost of the item includes a sum of the net cost of the item and an applied sales tax to the item based on multiplying the net cost by the non-zero integer. Accordingly, the generated cost notification related to the item and can be indicative of the gross cost of the item, the net cost of the item, the non-zero integer corresponding to the sales tax rate applicable to the item and the applied sales tax to the item discussed above in the non-limiting examples provided in FIGS. 3A-3F.

At operation 610, the cost notification module 412 can transmit the generated cost notification to the display monitor 400 corresponding to the display apparatus. From here, a customer shopping within the facility can view the cost notification and thereby be made aware of the true or gross cost that will be incurred by a customer who may desire to purchase the item. If the customer were not aware of the gross cost to purchase the item, additional costs including an applied sales tax would be hidden from a budget-conscious customer until the customer purchases the item at the checkout of the facility.

The above description of illustrated examples of the present invention, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A method for sending a cost notification to a display monitor corresponding to a display apparatus, the display apparatus furnished within a facility of a retailer, comprising:
obtaining, at a processing device of a display apparatus sever, display apparatus information corresponding to the display apparatus, the display apparatus information includes,
a. display apparatus preferences being indicative of an item explicitly preferred by the retailer for being stocked at the display apparatus, and
b. location specific information being indicative of a geographical location of the facility the display apparatus is furnished within;
generating, at the processing device, the cost notification related to the item based on the display apparatus information; and
transmitting, at the processing device, the generated cost notification to the display monitor.

2. A method of claim 1, wherein the obtaining the display apparatus information comprises:
receiving, at the processing device, a display apparatus identifier broadcasted from the display apparatus; and
retrieving, at the processing device, the display apparatus information from a display apparatus database using the display apparatus identifier, the display apparatus database storing display apparatus information for a plurality of display apparatuses furnished within one or more facilities by the retailer.

3. A method of claim 1, further comprising:
retrieving, at the processing device, item information from an item database using an item identifier corresponding to the item, the item database storing item information for a plurality of items offered for sale by the retailer, the item information includes
a. a net cost of the item, the net cost indicating a cost offered by the retailer to purchase the item excluding any applicable sales tax rate, and
b. a classification of the item.

4. The method of claim 3, wherein the classification of the item is selected from the group consisting of: groceries, prepared food, prescription medication, non-prescription medication, clothing, agricultural, alcohol/tobacco, and generally taxed items.

5. The method of claim 3, further comprising:
retrieving, at the process device, a sales tax rate applicable to the item from a sales tax database using the geographical location of the facility and the classification of the item, the sales tax database storing a plurality of sales tax rates corresponding to a plurality of classifications defined by a plurality of geographical locations as being one of taxable and exempt from being taxable; and
calculating, at the processing device, a gross cost of the item based on the net cost of the item and the sales tax rate, the gross cost indicating a cost to purchase the item at a checkout of the facility.

6. The method of claim 5, wherein calculating the gross cost of the item comprises:
when the geographical location of the facility defines the classification of the item as being exempt from being taxable:
determining, at the processing device, the sales tax rate applicable to the item is equal to zero and the gross cost is equal to the net cost.

7. The method of claim 5, wherein calculating the gross cost of the item comprises:
when the geographical location of the facility defines the classification of the item as being taxable:
retrieving, at the processing device, a non-zero integer from the sales tax database using the geographical location of the facility and the classification of the item, the non-zero integer corresponding to the sales tax rate applicable to the item;
multiplying, at the processing device, the net cost of the item by the non-zero integer;
determining, at the processing device, an applied sales tax to the item based on the multiplying; and
summing, at the processing device, the net cost of the item and the applied sales tax to the item to determine the gross cost.

8. The method of claim 6, wherein the generated cost notification is indicative of the gross cost of the item.

9. The method of claim 7, wherein the generated cost notification is indicative of the gross cost of the item and any combination of the net cost of the item, the non-zero integer corresponding to the sales tax rate applicable to the item and the applied sales tax to the item.

10. The method of claim 1, wherein the geographical location of the display apparatus is selected from the group consisting of: a country, a state, a province, a county, a borough, and a municipality.

11. A display apparatus server that sends a cost notification to a display monitor corresponding to a display apparatus, the display apparatus furnished within a facility of a retailer comprising:
a cost notification module configured to:
a. obtain display apparatus information corresponding to the display apparatus, the display apparatus information includes,
1. display apparatus preferences being indicative of an item explicitly preferred by the retailer for being stocked at the display apparatus, and
2. location specific information being indicative of a geographical location of the facility the display apparatus is furnished within;
b. generate the cost notification related to the item based on the display apparatus information; and
c. transmit the generated cost notification to the display monitor.

12. The display apparatus server of claim 11, wherein the cost notification obtains the display apparatus information by:
receiving a display apparatus identifier at a receiving module, the display apparatus identifier broadcasted from the display apparatus; and
retrieving the display apparatus information from a display apparatus database using the display apparatus identifier, the display apparatus database storing display apparatus information for a plurality of display apparatuses furnished within one or more facilities by the retailer.

13. A display apparatus server of claim 11, wherein the cost notification module is further configured to:
retrieve item information from an item database using an item identifier corresponding to the item, the item database storing item information for a plurality of items offered for sale by the retailer, the item information includes
a. a net cost of the item, the net cost indicating a cost offered by the retailer to purchase the item excluding any applicable sales tax rate, and
b. a classification of the item.

14. The display apparatus server of claim 13, wherein the classification of the item is selected from the group consisting of: groceries, prepared food, prescription medication, non-prescription medication, clothing, agricultural, alcohol/tobacco and generally taxed items.

15. The display apparatus server of claim 11, wherein the cost notification module is further configured to:
a. retrieve a sales tax rate applicable to the item from a sales tax database using the geographical location of the facility and the classification of the item, the sales tax database storing a plurality of sales tax rates corresponding to a plurality of classifications defined by a plurality of geographical locations as being one of taxable and exempt from being taxable; and
b. calculate a gross cost of the item based on the net cost of the item and the sales tax rate, the gross cost indicating a cost to purchase the item at a checkout of the facility.

16. The display apparatus server of claim 15, wherein the cost notification module calculates the gross cost of the item by:
when the geographical location of the facility defines the classification of the item as being exempt from being taxable:
determining the sales tax rate applicable to the item is equal to zero and the gross cost is equal to the net cost.

17. The display apparatus server of claim 15, wherein the cost notification module calculates the gross cost of the item by:
when the geographical location of the facility defines the classification of the item as being taxable:
retrieving a non-zero integer from the sales tax database using the geographical location of the facility and the classification of the item, the non-zero integer corresponding to the sales tax rate applicable to the item;
multiplying the net cost of the item by the non-zero integer;
determining an applied sales tax to the item based on the multiplying; and
summing the net cost of the item and the applied sales tax to the item to determine the gross cost.

18. The display apparatus server of claim 16, wherein the generated cost notification is indicative of the gross cost of the item.

19. The display apparatus server of claim 17, wherein the generated cost notification is indicative of the gross cost of the item and any combination of the net cost of the item, the non-zero integer corresponding to the sales tax rate applicable to the item and the applied sales tax to the item.

20. The display apparatus server of claim 11, wherein the geographical location of the display apparatus is selected from the group consisting of: a country, a state, a province, a county, a borough, and a municipality.
